(19) United States
(12) Patent Application Publication
(10) Pub. No.: US 2021/0049698 A1
(43) Pub. Date: Feb. 18, 2021

(54) PROGRAM AND PROCESS FOR REAL-TIME DEALER ASSESSMENT OF SERVICE CUSTOMER VEHICLE OWNERSHIP EFFICIENCY

(71) Applicant: BSD Partners, LLC, Grand Rapids, MI (US)

(72) Inventors: WILLARD S. STAWSKI, II, Caledonia, MI (US); SCOTT A. COULSON, Grand Haven, MI (US); DANNY J. ALLEN, Grandville, MI (US)

(21) Appl. No.: 16/939,126

(22) Filed: Jul. 27, 2020

Related U.S. Application Data
(60) Provisional application No. 62/887,249, filed on Aug. 15, 2019.

(51) Int. Cl. G06Q 40/06; G06Q 10/00; G06Q 40/02; G06Q 30/00; G06Q 10/08; G06Q 30/02; G06F 16/9535

(52) U.S. Cl. CPC G06Q 40/06; G06Q 10/20; G06Q 40/025; G06Q 30/016; G06Q 10/0875; G06Q 30/0278; G06F 16/9535; G06Q 30/0185

(57) ABSTRACT

The method includes the following: receiving at a program-server in communication with a plurality of remote endpoint data-source servers, real-time motor vehicle repair order data, live instant pre-screen consumer credit data and calculated motor vehicle values data; assembling customer data, instant pre-screen credit data and vehicle values data into a single service-event record; analyzing combined service-event record data to identify and mark pre-specified vehicle ownership inefficiency indicators within the record; transmitting said record including marked indicators to be viewed on a user display device; to be used to make accurate and timely ownership efficiency optimization recommendations to in-house repair facility service customers.

### CROSS-REFERENCE TO RELATED APPLICATIONS

Priority is claimed on Provisional Patent Application No. 62/887,249, filed Aug. 15, 2019, the contents of which are incorporated herein by reference.

### STATEMENT REGARDING FEDERALLY SPONSORED RESEARCH OR DEVELOPMENT

Not Applicable

### REFERENCE TO A “SEQUENCE LISTING”, A TABLE, OR A COMPUTER PROGRAM LISTING APPENDIX SUBMITTED ON COMPACT DISC

Not Applicable

This present disclosure relates generally to the commerce systems, and more particularly to the systemic multi-source collection, organization, validation and presentation of key consumer credit and motor vehicle valuation data, at motor vehicle service facilities, in real-time, as it relates to the assessment of motor vehicle ownership efficiency.

### BACKGROUND

The financial impact of motor vehicle ownership on the consumer is typically second only to that of home ownership. Where the value of a home is usually stable or increasing, which provides certain value-based benefits and assurances to the owner. An automobile is usually a decreasing value asset with increasing operating costs over time. The financial impact of motor vehicle ownership on the consumer is sizeable, constantly changing and largely unmonitored.

Economic efficiency, implies an economic state in which every resource is optimally allocated to serve the individual in the best way while minimizing inefficiency. Consumer credit, as a resource, plays a significant role in economic efficiency as it relates to consumer motor vehicle ownership. Just as vehicle values change over time, consumer credit does also. With this multi-variable state, a real-time assessment solution is needed to adequately and accurately serve the consumer.

As motor vehicle values decrease and operating expenses increase, the dynamic between cost and benefit changes. Ownership Efficiency (OE) is a numerical expression of the present relationship between operating costs and vehicle value. Measuring this cost/benefit ratio enables the consumer to recognize inequities and then evaluate more efficient options. OE is most greatly affected by variables such as a change in vehicle value, increased maintenance expenses, warranty termination and a change in consumer credit capability.

OE Optimization is the process of evaluating and improving a consumer's Ownership Efficiency. OE Optimization can play an important role in consumer financial planning. Increasing vehicle quality and decreasing vehicle expenses has a material impact on the consumers financial state, vehicle dependability, safety and consumer disposition.

The embodiment described herein allows motor vehicle dealers to provide real-time OE analysis and OE Optimization recommendations to their customers. By systematically gathering, assessing and presenting key OE Factors in real-time, the embodiment described herein allows motor vehicle dealers to quickly and accurately assess the OE on vehicles under their purview. Once an ownership inefficiency is identified, the dealer may then provide accurate insight on meaningful changes that can be made to improve the consumer's position, OE Optimization.

### SUMMARY

The program described herein allows dealers, to systematically check vehicle values and live consumer credit data on customers as they open repair orders at the dealership. The process allows a dealer to identify those service customers with the greatest need of OE Optimization within minutes of a repair order being opened. The dealer will provide OE Optimization consultation before the customers service work is completed. Due to inherent time constraints, access to real-time credit data is critical during the vehicle repair period. The program utilizes Application Programmable Interfaces (API) with three or more data providing services in order to gather, organize, identify, optimize, then present to sales persons, those customers with the greatest need of OE Optimization.

The process begins by the program extracting and identifying new repair order customers from the dealer's dealership management system (DMS). When a new repair order is identified, the program sends vehicle information to a vehicle valuation service using the service vehicle's Vehicle Identification Number (VIN) and mileage. The retuned data on the service vehicle is then checked against the dealer's pre-defined year model range parameters. On vehicles that fall within the range threshold specified, the service customer's name and address is then submitted to a credit data provider to obtain live, instant prescreen credit data.

The data gathered from the DMS, vehicle valuation service and credit data provider are then assembled into a data file. The data file is then analyzed by the program to identify customers in need of OE Optimization. The program uses key efficiency factors to identify those customers.

By integrating multiple independent data sources, the program provides a vehicle ownership snapshot to the dealer on each service customer within minutes of opening a new repair order. With real-time vehicle and credit data, the dealer can assess which service customers have the greatest need for OE Optimization and then work with those customers to improve their OE before the service work is completed.

### BRIEF DESCRIPTION OF DRAWINGS

FIG. 1 illustrates an example of a network in which embodiments described herein may be implemented.

FIG. 2 depicts an example of a network device useful in implementing embodiments described herein.

FIG. 3 is a flowchart illustrating an overview of the program process including dealer input, network device interaction, data collection, results assessment and categorization, program alerts and results output to the dealer.

FIG. 4 is a block diagram illustrating interaction between different multiple disparate data sources and the program server.

FIG. 5 depicts an example of the Results Summary Page displayed on the dealer device

FIG. 6 depicts an example of the Results Detail Page displayed on the dealer device

FIG. 7 depicts an example of the printed Consumer Results Detail Page

FIG. 8 and FIG. 9 are a flowchart illustrating the decision tree and formulas used to determine whether there are enough efficiency factors to indicate an opportunity for an Ownership Efficiency Optimization.

Corresponding reference characters indicate corresponding parts throughout the several views of the drawings.

### DESCRIPTION EXAMPLE OF EMBODIMENTS

### Overview

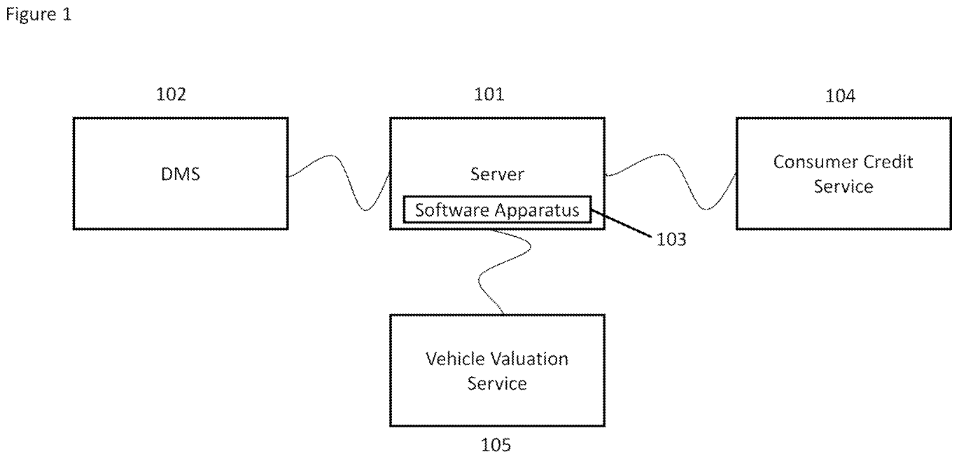

In FIG. 1, in one embodiment, a method generally comprises receiving at a server (101) in communication with a DMS (102), notification of a state change where a new service repair order has been created. The server is used to host the software apparatus which gathers and compares data from multiple independent sources and then identifies key efficiency factors. The independent data sources include both real-time “live” consumer credit data (103) provided by a credit data provider and current vehicle and valuation data provided by a vehicle valuation service (104). The real-time gathering, organization, categorization and representation of interrelated and independent data sources enable dealers to assess a customer's OE with unprecedented accuracy.

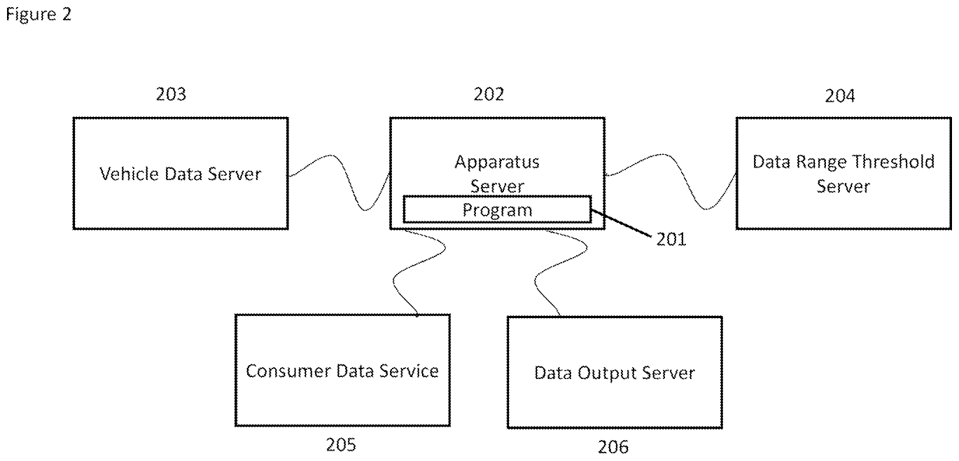

In FIG. 2, in another embodiment, an apparatus (201) generally comprises a processor located on the first server (202), operable to communicate with a plurality of servers, to intermittently check for a change in data indicating that a new repair order has been created or an existing repair order has been closed from a second server device (203), submitting consumer vehicle data from the second server device to a third server device, checking returned data from the third server device (204) against a user's pre-set year model range located on the first server device, submitting the consumer's personal data to a fourth server device (205), where the first server device then organizes consumer and vehicle data to illustrate current vehicle ownership efficiency, before submitting the final calculations to a fifth server device (206). The apparatus further comprises memory for storing data obtained from the server devices. The server is used in to execute functions of the apparatus, based on data originating from the second server device, presenting its final calculation output to the fifth server device.

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown but are to be accorded the widest scope consistent with the principles and features described herein. For purpose of clarity, details relating to technical material that is known in the technical fields related to the embodiments have not been described in detail.

A user, or motor vehicle service advisor, may open a new service order for a customer who has brought their vehicle to a service facility to have the vehicle serviced. The service advisor creates a new repair order via DMS software application hosted from a server. The service record includes the vehicle owner's name, address, vehicle identification number, mileage, and other vehicle specific data. The repair order is utilized to track all services performed to the customer's vehicle, and to calculate the customer's final costs for the services or repairs made to the vehicle.

In the above example, limited, raw data, sourced from the repair order, may be available to salespersons at the automobile dealership. Data is without any representation as to the vehicle owner's financial investment into the vehicle, credit score or representation of the vehicle owner's propensity to replace the vehicle which they have just presented to the dealership's service department. Salespersons who choose to review the vehicle's service data will make an estimation as to the consumer's interest in replacing their current vehicle while at the dealership based upon the data presented in the repair order only.

The embodiments described herein provide notification between dissimilar endpoints, the dealership's DMS server, and an employee within the dealership's sales department viewing the server's repair order raw data. The embodiments provide raw data, which is managed by the DMS repair order platform, which provides record keeping and billing services for the vehicle which has been admitted for service. There is a data calculation process which occurs between the service order platform and applications utilized by the dealership's sales organization.

The term ‘calculation’ is used herein refers to any type of data calculation which includes data sources which are provided from within and outside of the dealership's own data systems and platforms. Calculations include data sourced from the dealership's dealership management system, vehicle valuation providers, consumer credit data providers and optimization processes provided by the apparatus.

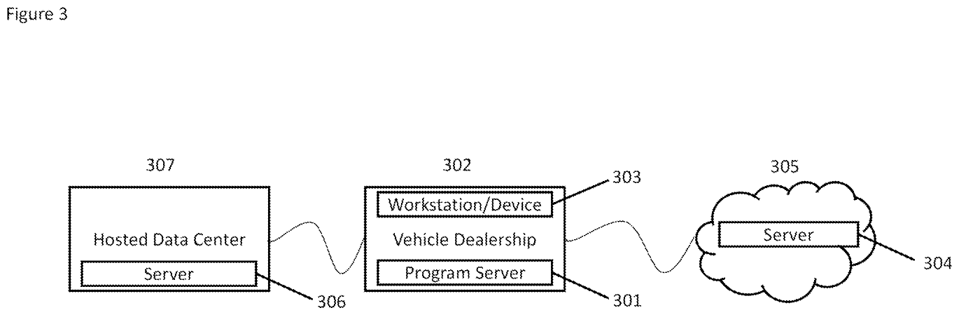

In FIG. 3, the embodiments operate in the context of a data communications network including multiple network devices such as servers, workstations, terminals and portable devices. Some of the devices in the network may be servers (301) which are local within the dealership's local location (302), user portable devices, terminals or workstations (303) within the dealership's local location, servers (304) which are located within the dealership's cloud hosting location (305), or servers hosted (306) by third party providers of vehicle and consumer data which are independent of the dealership's locations (307).

Referring now to the drawings, example of a network in which embodiments descried herein may be implemented is shown. A plurality of endpoints (e.g., servers, workstations, terminals and portable network devices) are in communication via network. The network may include one or more networks. The nodes of the network are connected via communication links. Communication flow paths between the endpoints may include any number of intermediate nodes which facilitate passage of data between nodes.

An example of a network device useful in implementing embodiments described herein, shows a device whereby the Dealer is able to alter settings, including the specification of a vehicle year model range, as well as review Program output regarding consumer customers individual economic efficiency as it pertains to service customer service vehicle ownership.

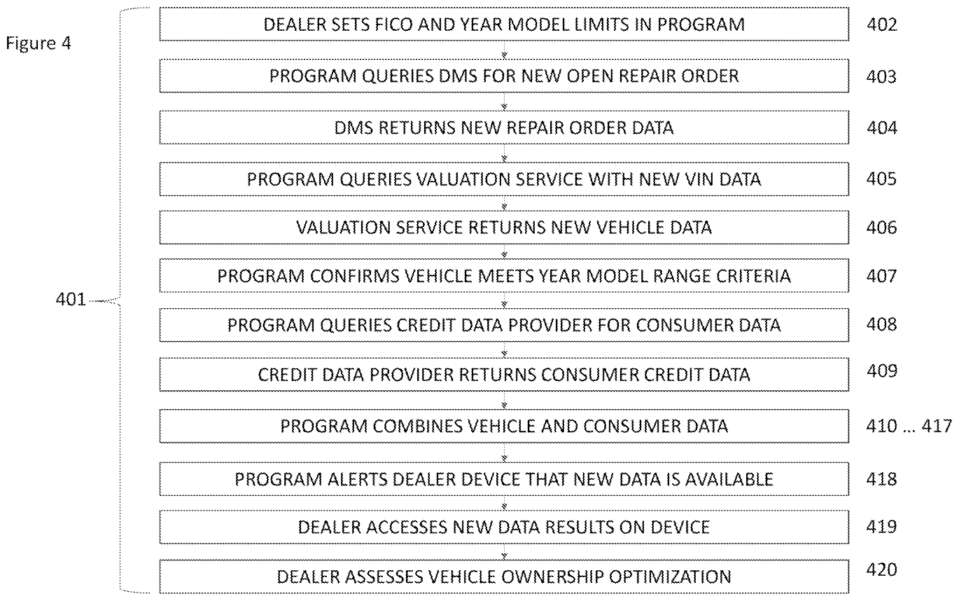

Referring to FIG. 4, a flowchart (401) illustrating an overview of a process for dealer input, network device interaction, data collection, results assessment and categorization, program alerts and results output to the Dealer and FIG. 4, a block diagram illustrating interaction between different 10 disparate data sources and the server, a detailed description is as follows:

The first step in the process is for the dealer to enter a desired service vehicle year model range in the program settings (402). Consumer credit will not be requested on service customers with service vehicles older than the low year limiter or newer than the high year limiter. The program allows the dealer to change this system setting at any time through a dealer input network device.

The second step in the process is for the program to interact with the DMS server (403) through an Application Program Interface (API) tie-in. The program maintains a list of repair orders that are open as indicated by the DMS. The program queries the DMS on a regular and frequent basis for an updated list of open repair orders.

When the updated list shows a repair order present (404) that was not on the most recently extracted list, a new repair order data file is created by the program and the data gathering process defined below begins. When the updated list no longer shows a repair order that was on the most recently extracted list, the program changes the repair order status to “Closed” indicated on the dealer's network display device.

When a new open repair order is activated, the first program-initiated query is sent to a vehicle valuation service server (405) through an established API tie-in (406). From the DMS server provided customer data, the program submits the service vehicle VIN and mileage and requests the vehicles year, make, model, trade value and retail value. The program then checks the service vehicle year model against the dealer's program setting for year model range (407).

If the service vehicle year model falls outside the dealer's year model range limit, then no further action is taken by the program and the process terminates.

If the service vehicle year model falls within the dealer's year model range limit, the program then initiates a query to a consumer credit data provider server (408) through an established API tie-in. The program submits the service customers name and address and requests back all pertinent auto trade-line information through an instant prescreen soft pull credit report.

On records returned (409) by the credit data provider, the consumer credit data includes a live FICO score, current open and recently closed auto trade-line information, recent auto inquiries and available revolving credit.

Once the service vehicle data and consumer credit data are gathered, the program creates a new combined record (410) that includes service vehicle data, vehicle values data and service customer credit data. From this combined record, the program is then able to isolate certain factors that impact OE. While each OE Factor, on its own, may not significantly impact OE, multiple factors present on a customer's combined record may indicate that an OE assessment is needed. Seven key OE Factors are checked by the program on each new combined record.

The first OE Factor (411) contemplated by the program is the service customers live FICO score expressed both numerically and in a standardized eight (8) tier format. Scores above a pre-defined number are marked by the program indicating an OE factor is present. The customer summary page is changed by the program to indicate that the service customer is worthy of special credit consideration by the dealer.

The second OE Factor (412) contemplated by the program is the service customers level of debt on the service vehicle. Auto-lines that are greater than 50% paid are marked by the program indicating an OE Factor is present. The customer summary page is changed by the program to indicate that the service customer may have equity in the service vehicle.

The third OE Factor (413) contemplated by the program is when the service customers credit shows an open auto-line with 12 or fewer payments remaining. Open auto-lines with 12 or fewer payments remaining are marked by the program indicating an OE Factor is present. The customer summary page is changed by the program to indicate that the service customer has an open auto-line within one year of payoff.

The fourth OE Factor (414) contemplated by the program is customer interest rate disparity. To determine an interest rate disparity, the program checks the service customers FICO score against all open auto-line interest rates using an established rate disparity table stored in the program. Records that exhibit a disparity between the service customers FICO score and the interest rate being paid on any open auto-line are marked by the program indicating an OE Factor is present. The customers summary page is changed by the program to indicate that the service customers interest rate does not match the customer's credit quality.

The fifth OE Factor (415) contemplated by the program is service vehicle mileage. Records where the service vehicle has greater than 90,000 miles are marked by the program indicating that an OE Factor is present. The customers summary page is changed by the program to indicate that the service vehicle mileage warrants a maintenance expense review.

The sixth OE Factor (416) contemplated by the program is the service vehicles number of days in service. The program monitors the data returned by the DMS server and tracks service vehicle days in service. Service vehicles that reach or exceed seven days in service are marked by the program indicating that an OE Factor exists. The customer summary page is changed by the program to indicate that the repair expenses on the service vehicle require review.

The seventh OE Factor (417) contemplated by the program is the number of auto inquiries appearing on the service customers credit report over the previous thirty days. Records that indicate one or more credit inquiries have been made are marked by the program indicating that an OE Factor exists. The customer summary page is changed by the program to indicate that the service customer may be considering a change in vehicle ownership.

When the combined record is created and all OE Factors are identified and marked, the program calculates and annotates a service customer status on the combined record. Records with three or more OE Factors present are marked by the program with a priority status indicator. Records with one or more auto inquiry are marked with a priority status indicator. Service vehicles with seven or more days in service are marked with a priority status indicator.

Once all information has been gathered, the combined record has been created, all OE Factors have been assessed and a customer status has been assigned, the program sends a pop-up notification (418) to the dealers display device indicating that a new repair order has been opened.

The dealer views the pop-up notice on a display device (419) and acknowledges the repair order pop-up to the program through an input device. Upon acknowledgement, the program adds the new repair order record to the service summary list. The sales person may then assess the program's output and customer propensity data (420).

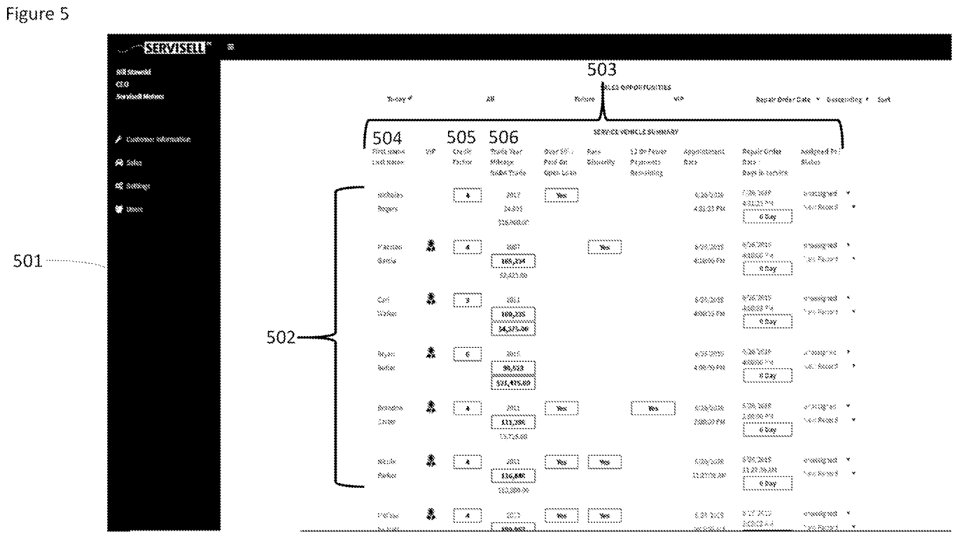

FIG. 5, the service summary list (501) is arranged with rows (502) indicating individual customer records and columns (503) indicating certain record elements and OE Factors. The default order of the service summary list displays the most recently opened repair order on top with the next most recent open repair order displayed on the next row and so on. The service summary list is maintained by the program and displayed on the dealer's portable device, terminal or workstation.

The dealer has the option to sort the service summary list based on several column fields including customer name (504), credit factor (505), service vehicle year model and service vehicle mileage (506). The dealer may also sort the list in ascending or descending order. The program receives list sort input from the dealers input device and then arranges the service summary list in accordance with the input options selected by the dealer. The newly sorted list is then displayed on the dealer's portable device, terminal or workstation.

For each customer record displayed on the service summary list, the program displays customer information, service vehicle information, OE Factors and repair order status information. The program uniquely highlights each customer row depending on repair order status. Color coding is applied by the program to illustrate different repair order status. Repair order status includes open repair orders, open repair orders less than three hours old, closed repair orders and future appointments.

Within each customer row appearing on the service summary list, the program highlights certain fields in order to illustrate the degree to which each service customer requires OE assessment. Highlighted fields include the priority status indicator and any OE Factors that have been identified by the program for that customer record. By highlighting pertinent OE Factors, the program creates a visual representation on the dealer screen that is easy to discern and allows for immediate and accurate customer record prioritization.

Service summary list navigation and customer record selection is made possible as the program automatically highlights each customer record row as the dealer moves the input device mouse cursor over the service summary list records. The dealer may select a customer record from the program user interface to review by selecting the desired customer record highlighted within the service summary list presented.

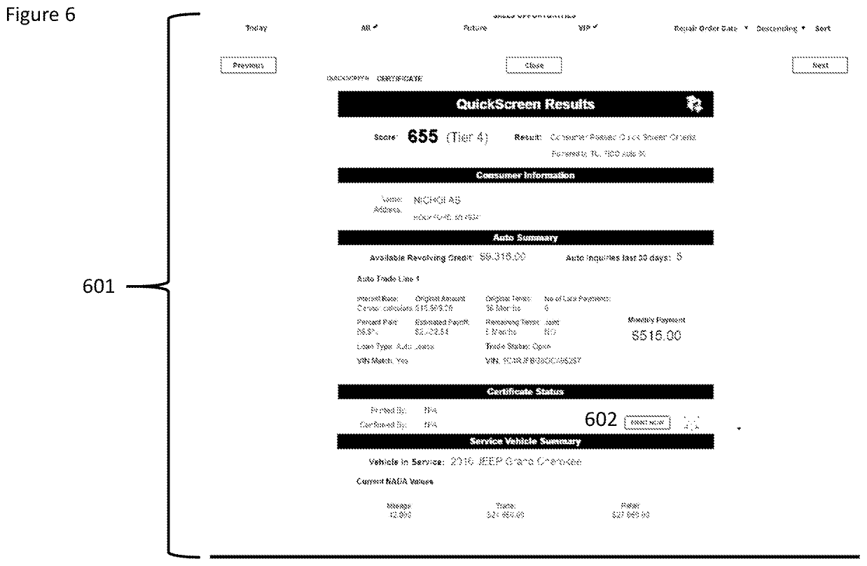

FIG. 6, customer summary screen (610), when a dealer clicks the highlighted record on the service summary list, the program extracts live consumer credit data provided by the credit data provider and service vehicle and values data provided by the vehicle valuation service. The program then combines the two datasets and displays the results on the dealer's portable device, workstation or terminal. The proprietary combination of live instant pre-screen data and current vehicle values data gives a dealer the most accurate real-time data available for OE assessment.

Live data displayed on the customer summary screen gives the dealer calculation data to help discern which customers have the greatest need for OE Optimization. When a customer has been identified as an OE Optimization candidate, the dealer may produce a printable customer summary (602) on the candidate customer.

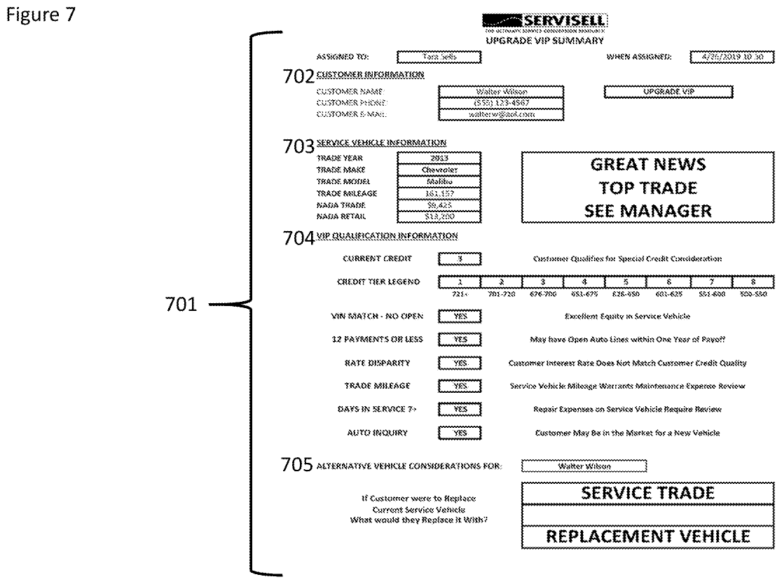

FIG. 7, the printable customer summary (701), the program accesses the combined customer Data File for the service customer and generates a printable summary. The summary is organized in four parts, Customer Data (702), Service Vehicle Information (703), VIP Qualification Information (704) and Alternative Vehicle Consideration information (705). The Summary is provided as a dealer resource to be used when working with a service customer personally.

All applicable OE Factors that have been identified by the program are delineated on the printable summary. The printable summary is used by the dealer as a guide in working with the service customer. The printable summary contains no specific consumer credit information.

The process and program collect, organize, categorize and then display substantial amounts of live consumer and vehicle data. The standardization of OE Factors allows the program to quantify the key elements of vehicle OE. The program and process, using live data, allow the dealer to accurately assess each service customers level of OE as they move through the service drive daily.

The daily flow of service traffic provides an appropriate and likely venue for automated dealer OE assessment. The customers that bring their vehicles into a dealership for service have varying and ever-changing degrees of vehicle OE. In addition to providing vehicle service work, the dealer is ultimately qualified to accurately assess a customer's current OE. The dealer is also in a unique position to make meaningful recommendation towards customer OE Optimization. The embodiment defined herein provides an unprecedented process and program for dealers to use to identify those service customers with the greatest need of vehicle OE Optimization.

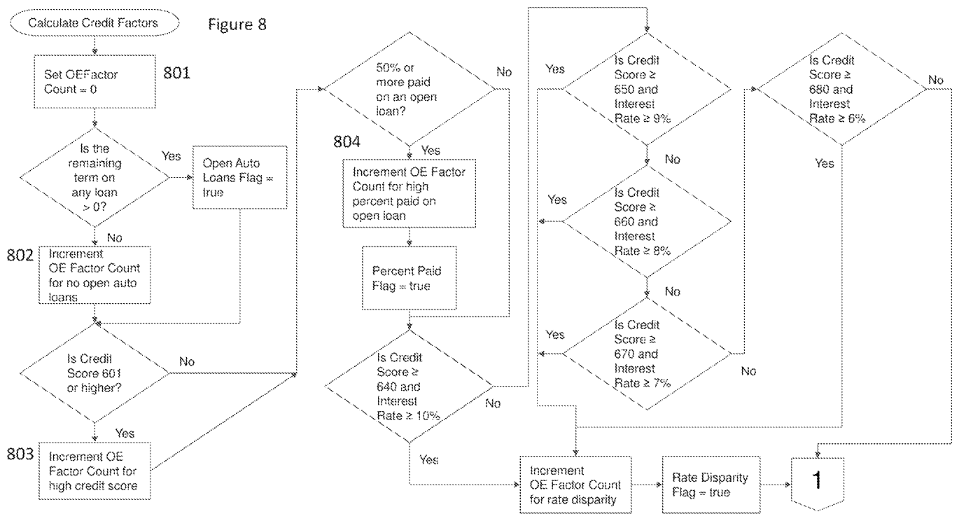

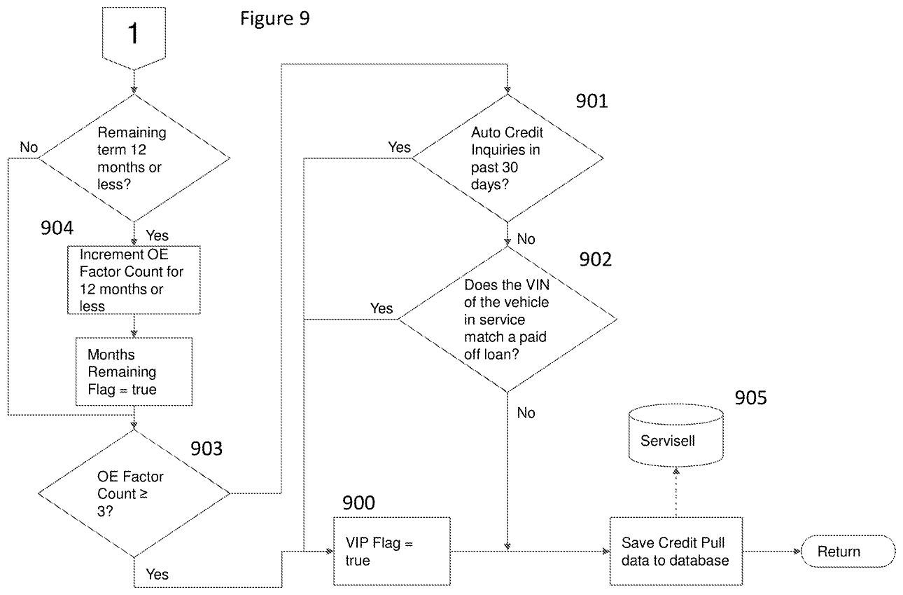

Identification of an opportunity for an OE Optimization is determined using the process detailed in FIG. 8 and FIG. 9 and the real-time data retrieved from Customer Credit Service and the Vehicle Valuation Service. An OE Optimization opportunity is indicated by an auto credit inquiry within the past 30 days (901), a closed loan matching the VIN of the vehicle in service (902) or 3 or more of the OE Factors being present (903). OE factors are represented in the figures as flags indicating a true or false state. If 3 or more flags are set to true, this indicates an opportunity for an OE Optimization. The VIP Flag (900) represents a true or false state indicating whether or not an OE optimization opportunity is present. Initially the OE factor count is set to 0 (801). Next, if there are no open auto loans, the OE Factor count is incremented (802). If the vehicle owner has a credit score greater than or equal to 601, the OE Factor count is incremented (803). If an open loan has a percent paid of 50% or more, the OE Factor is incremented (804). If an interest rate disparity is shown, the OE Factor is incremented (805). An interest rate disparity is when the interest rate for a loan is higher than would typically be charged given the credit score of the vehicle owner. An interest rate disparity is shown if the credit score of the owner of the vehicle in service (score) is greater than or equal to (≥) 640 and the interest rate on an open loan (rate) is ≥10%, or if the score ≥650 and the rate ≥9% or the score ≥660 and the rate ≥8%, or if the score ≥670 and the rate ≥7%, or the score ≥680 and the rate ≥6%. If there are 12 or fewer months remaining on an open loan (904), the OE Factor is incremented. The individual OE Factors and the VIP flag are then stored in the local database (905) for real-time retrieval and display by the user.

We claim:

1. A method comprising: receiving at a program-server in communication with a plurality of remote endpoint data-source servers, motor vehicle repair order data, prescreen consumer credit data and motor vehicle values data; assembling customer data, prescreen consumer credit data and vehicle values data into a single service-event record; analyzing service-event record data to identify and mark pre-specified vehicle ownership inefficiency indicators within the record; transmitting said record including marked indicators to be viewed on a user display device; to be used to make accurate and timely ownership efficiency optimization recommendations to service facility customer.

2. The method of claim 1, wherein a petition for an open repair order list is made comprised of program-server submitting a data query to service-facility server.

3. The method of claim 2, wherein a data check for new open repair order records is made comprised of program-server submitting a subsequent data query to the service-facility server and comparing the updated open repair order list against the most previous open repair order list provided by the service-facility server.

4. The method of claim 3, wherein a new repair order is identified as having been opened at the service facility comprising program-server isolating a new record found on the new open repair order list.

5. The method of claim 4, wherein a new service-event record is created comprised of program-server creating a new file containing: repair order open date and time, customer name, physical address, email address, telephone number, service vehicle Vehicle Identification Number and service vehicle mileage received from the service-facility server.

6. The method of claim 5, wherein service vehicle values data is requested comprised of program-server submitting service vehicle Vehicle Identification Number and service vehicle mileage to vehicle-values server.

7. The method of claim 5, wherein service vehicle information is obtained comprised of vehicle-values server returning service vehicle year, make, model, current trade value and current retail value to program-server.

8. The method of claim 5, wherein the service-event record is updated comprised of program server updating vehicle fields in service-event record with data received from the vehicle-values server.

9. The method of claim 5, wherein prescreen consumer credit data is requested comprised of program-server submitting service customer name and address information to consumer-credit server.

10. The method of claim 5, wherein prescreen consumer credit data is obtained comprised of consumer-credit server returning service customer prescreen consumer credit data to program-server.

11. The method of claim 5, wherein the service-event record is updated comprised of program server updating consumer credit fields in service-event record with prescreen consumer credit data received from the consumer-credit server.

12. The method of claim 5, wherein a complete service-event record is published comprised of program server validating complete service customer data, complete service vehicle and values data and complete prescreen consumer credit data.

13. The method of claim 12, wherein the complete service-event record is checked for a series of pre-specified static vehicle ownership inefficiency data indicators comprised of the program-server checking and marking:
a service vehicle mileage of greater than a pre-specified mileage amount,
a service customer credit score within a pre-specified numerical range,
a service customer open auto trade line that is greater than a pre-specified percentage paid,
a service customer open auto trade line within a pre-specified number of calendar months of payoff,
a service customer record with recent motor vehicle dealer credit inquiries,
a service customer with an open auto trade line interest rate and consumer credit score that is disproportionate as compared to a pre-specified set of numerical range limits,
a service vehicle with a repair order open for greater than six consecutive days.

14. The method of claim 13, wherein the service-event record is categorized as needing vehicle ownership optimization review comprised of the program-server checking for and marking:
a service-event record with three or more marked vehicle ownership inefficiency data indicators,
prescreen consumer credit data that includes a service vehicle auto trade line that is paid off,
prescreen consumer credit data that includes an automobile dealer credit inquiry within the preceding 30 days,
a vehicle repair order open for more than six consecutive days.

15. The method of claim 14, wherein the marked and categorized service-event record is made available to user comprised of the transmission of a visual representation of service-event record to a user display device.

16. The method of claim 15, wherein displayed data is used to make accurate and timely ownership efficiency optimization recommendations to service facility customer comprised of user interface with service facility customer referencing displayed data to recommend service vehicle ownership optimization solutions
